(19) United States
(12) Patent Application Publication
(10) Pub. No.: US 2010/0027825 A1
(43) Pub. Date: Feb. 4, 2010

(54) Ear mold for a hearing device

(76) Inventors: Werner Fickweiler, Bubenreuth (DE); Uli Gommel, Erlangen (DE); Thomas Lotter, Heroldsberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/510,303

(22) Filed: Jul. 28, 2009

(30) Foreign Application Priority Data
Aug. 4, 2008 (DE) 10 2008 036 0258.

(51) Int. Cl. H04R 25/00

(52) U.S. Cl. 381/330; 381/322

(57) ABSTRACT

In one aspect an ear mold for a hearing device is provided. The ear mol includes an opening for accommodating a snap-on element arranged on a receiver or a sound tube, with the opening being lined with a hard layer. A device having a receiver or a sound tube and a snap-on element are likewise specified.

### CROSS REFERENCE TO RELATED APPLICATIONS

This application claims priority of German application No. 10 2008 036 0258.1 DE filed Aug. 4, 2008, which is incorporated by reference herein in its entirety.

### FIELD OF INVENTION

The invention relates to an ear mold for a hearing device, a receiver or a sound tube with a snap-on element and a behind-the-ear hearing device.

### BACKGROUND OF INVENTION

In the case of the behind-the-ear and in-the-ear hearing devices found on the market, it is generally necessary to connect an earpiece which is adjusted to the auditory canal of the hearing device wearer to an in-the-ear loudspeaker. Different solutions exist depending on the embodiment of the earpiece in order to produce a secure connection.

For individually adjusted earpieces, also known as ear molds, the ear shape of a hearing device user is inspected and a shell or body is manufactured in a fixed and/or hard embodiment in accordance herewith. The hard embodiment is for instance an otoplastic or a plastic shell manufactured using rapid prototyping technology. In these instances, a “hard snap connection” is preferably selected as the mechanical connection between the loudspeaker, also known as the receiver, and the earpiece. This so-called “hard-hard compound” is shown schematically in FIG. 1. A cone-shaped hard snap-on element 1 of a loudspeaker 3 can be snugly inserted into an opening 2 of a hard earpiece 4. The snap-on element 1 securely engages in the opening 2 by means of the undercut of the cone-shaped snap-on element 1. As a result of the hardness of the materials, the connecting elements 5 can be embodied to be relatively small.

With another solution, the earpieces are not adjusted individually, but instead the hearing device user can select from a limited number of differently sized flexible earpieces made of a soft material, for instance silicon. Different soft earpieces cover the different auditory canal shapes of the hearing device wearers. Since the respective earpiece does not fit exactly in respect of the respective auditory canal, the earpiece is usually reversibly deformed during insertion into the auditory canal. It must therefore be embodied to be as elastic as possible, so as to convey a pleasant sensation when being worn. On the other hand, the plug-in connection to the loudspeaker must be sufficiently firm to ensure a secure hold in the earpiece. A minimum size of the snap-on element of the loudspeaker is required here. FIG. 2 shows a schematic representation of this so-called “hard-soft compound”. A cone-shaped, hard snap-on element 1 of a loudspeaker 3 can be snugly inserted into an opening 2 of a soft earpiece 4 by deforming this. Due to the different material hardnesses, the connecting elements 5 must be embodied to be relatively large to ensure a secure hold.

One further disadvantage of the “hard-soft compound” is that it can result in abrasion of the soft material as a result of snapping on the hard material. The geometry of the snap-on element must however be embodied “aggressively”, thereby ensuring a secure hold. The snap-on connection can thus no longer be reliably maintained after a certain number of plug-in cycles.

One example of an ear mold is specified in WO 96/21334. With an in-the-ear hearing device, a receiver module positioned deep inside the ear is provided with a soft material so that it sits securely in the auditory canal.

### SUMMARY OF INVENTION

It is the object of the invention to specify an apparatus, which results in a standardization and improvement in a snap-on connection between an in-the-ear loudspeaker and an ear mold.

According to the invention, the set object is achieved with the ear mold, with the receiver and/or sound tube and the snap-on element as well as with the behind-the-ear hearing device of the independent claims.

In accordance with the invention, an ear mold is claimed for a hearing device comprising an opening for accommodating a snap-on element arranged on a means, preferably on a receiver or on a sound tube, with the opening being lined with a hard layer. This is advantageous in that the connection is suited both to soft as well as to hard ear molds.

In a further embodiment, the layer can include a coating of the surface of the opening or a separate part, which can be pressed into the opening. As a result, the layer can be easily inserted into the opening.

In a development of the invention, the ear mold can be formed from a soft, flexible plastic and the layer can be formed from a hard plastic. Coating of a soft plastic with a hard plastic is easily possible from the manufacturing standpoint. The soft parts of a flexible ear mold can be embodied to be softer than those without a hard layer, thereby increasing the wearing comfort for a hearing device wearer.

In a further embodiment, the soft plastic may be silicon. Silicon is an established soft material which is easy to handle.

The layer can preferably be formed from metal. The advantageous point here is the considerable hardness, and the fact that the layer can subsequently be introduced into the opening.

Furthermore, the layer can be fixed into the opening by means of chemical bonding, adhesion or adhesive sealing. This is advantageous in terms of a durable connection between the layer and the ear mold.

In one development, a part of the opening can take the form of a sphere. As a result, the associated snap-on element can be embodied to be small.

The invention also claims a receiver and a sound tube with a snap-on element, with the snap-on element being embodied such that it can be snugly accommodated by the spherical opening in an inventive ear mold.

In one development, the spherical snap-on element can include a cylindrical connecting element, with the snap-on element and the connecting element being embodied in one piece and the connecting element being connectable to the receiver or the sound tube. The spherical joint herewith allows a reliable, durably-robust, abrasion-free mechanical connection. A hearing device user is able to insert an ear mold him/herself and easily remove it again by means of a circular motion.

In a further embodiment, the receiver can include a receiver housing, and the snap-on element, the connecting element and the receiver housing can be made of metal and the connecting element can be welded to the receiver housing. This offers an optimum and secure, but also detachable snap-on connection.

The invention also claims a behind-the-ear hearing device with an inventive ear mold.

In a further embodiment, the behind-the-ear hearing device can include an inventive receiver or an inventive sound tube.

### BRIEF DESCRIPTION OF THE DRAWINGS

Further details and advantages of the invention are apparent from the subsequent explanations of an exemplary embodiment with reference to schematic drawings, in which;

FIG. 1: shows a “hard-hard” snap-on connection according to the prior art,

FIG. 2: shows a “hard-soft” snap-on connection according to the prior art,

FIG. 3: shows an inventive snap-on connection with a receiver and a flexible ear mold and

FIG. 4: shows an inventive snap-on connection with a sound tube and an ear mold adjusted to a hearing device wearer.

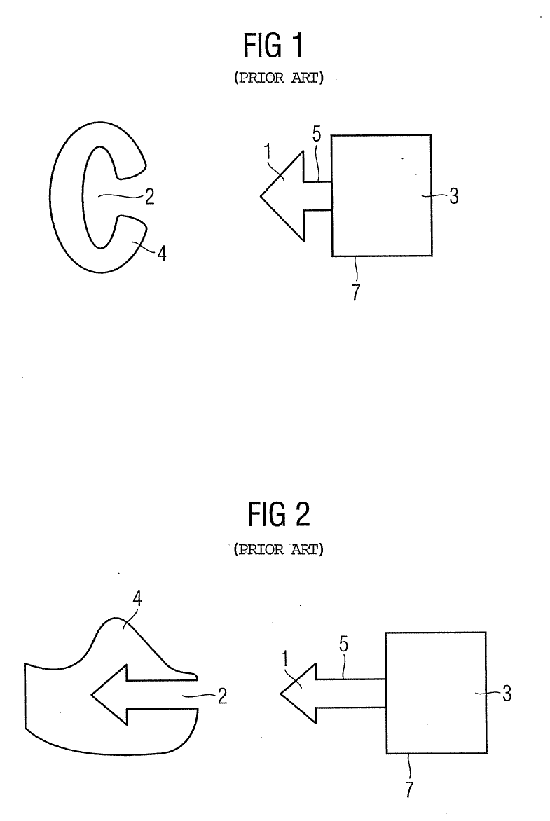

### DETAILED DESCRIPTION OF INVENTION

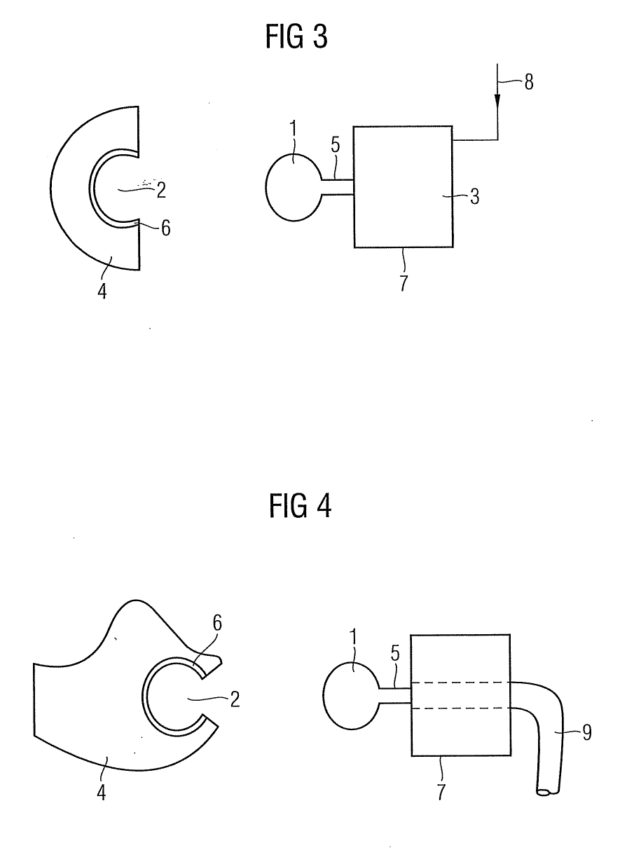

FIG. 3 shows a cross-section through an inventive ear mold 4 as well as a schematic representation of an inventive receiver 3 with a snap-on element 1. The ear mold 4 is made of a soft plastic, for instance silicon, and has a spherical opening 2, which is lined with a hard layer 6. The hard layer 6 makes the soft surface of the opening into a hard one, into which the snap-on element 1 of the receiver 3 can engage. This produces a robust, abrasion-free connection. The snap-on element 1 is likewise spherical and is fixedly connected to a housing 7 of the receiver 3 by means of a connecting element 5. The snap-on element 1 and connecting element 5 are preferably produced in one piece and from metal. The connecting element 5 is molded in a cylindrical fashion for instance. The receiver housing 7 is likewise made of metal. The snap-on element 1 is welded to the receiver housing for a secure hold. A hearing device wearer can thus easily connect the receiver 3 to a selected ear mold 4. A simple rotation once again allows the receiver 3 to be removed from the ear mold 4.

The receiver 3 is connected to a behind-the-ear part (not shown) of a hearing device comprising an electrical supply line 8 for transmitting electrical sound signals. The electrical signals are converted into acoustic sound signals in the receiver 3.

FIG. 4 shows a cross-section through an individually manufactured ear mold 4 and a sound tube 9 with a spherical snap-on element 1. The ear mold 4 is formed from a relatively hard plastic, in accordance with the auditory canal shape of a hearing device user, since it must no longer be deformable. To accommodate the snap-on element 1, the ear mold 4 has a spherical opening 2. The surface of the opening 2 is coated with a hard layer 6, for instance made of metal. The metal is fixed to the opening with adhesive. Alternatively, a very hard plastic can also be selected. This can be applied for instance using rapid prototyping at the same time as assembly of the ear mold 4. As a result, the layer 6 chemically connects to the ear mold 4. In a similar manner to the embodiment according to FIG. 3, the snap-on element 1 is fixedly connected to a housing 7 by means of a connecting element 5, said housing sealing an end of the sound tube 9.

The ear mold 4 is connected to a behind-the-ear part (not shown) of a hearing device comprising a sound tube 9 for transmitting acoustic sound signals. Electrical sound signals are converted here into acoustic sound signals in a behind-the-ear part of the hearing device.

1.-14. (canceled)

15. An ear mold for a hearing device comprising:
an opening lined with a hard layer and for accommodating a snap-on element arranged on a hearing aid element.

16. The ear mold as claimed in claim 15, wherein the hard layer is a coating of the surface of the opening or a separate part in the opening.

17. The ear mold as claimed in claim 15, wherein the hearing aid element includes a receiver or a sound tube.

18. The ear mold as claimed in claim 15, wherein the ear mold is formed from a soft, flexible plastic.

19. The ear mold as claimed in claim 18, wherein the soft plastic is silicon.

20. The ear mold as claimed in claim 16, wherein the ear mold is formed from a soft, flexible plastic.

21. The ear mold as claimed in claim 20, wherein the hard layer is formed from metal or a hard plastic.

22. The ear mold as claimed in claim 15, wherein the hard layer is formed from metal or a hard plastic.

23. The ear mold as claimed in claim 15, wherein the hard layer is fixed in the opening via a chemical bonding, adhesion or adhesive sealing.

24. The ear mold as claimed in claim 15, wherein at least part of the opening is spherical.

25. A hearing aid element, comprising:
a first part selected from the group consisting of receiver and sound tube; and
a snap-on element embodied such that it is snugly accommodated by the opening of an ear mold including an opening lined with a hard layer.

26. The hearing aid element as claimed in claim 25,
wherein the snap-on element is spherical and includes a connecting element,
wherein the snap-on element and the connecting element are formed in one piece, and
wherein the connecting element is connected to the first part.

27. The hearing aid element as claimed in claim 26,
wherein the first part is the receiver, and
wherein the snap-on element, the connecting element and the receiver housing are made of metal and the connecting element is welded to a housing of the receiver.

28. A behind-the-ear hearing device, comprising:
an ear mold comprising an opening lined with a hard layer and for accommodating a snap-on element arranged on a hearing aid element.

29. The behind-the-ear hearing device as claimed in claim 28, further comprising:
the hearing aid element, comprising a first part selected from the group consisting of receiver and sound tube, and a snap-on element embodied such that it is snugly accommodated by the opening of the ear mold.

30. The behind-the-ear hearing device as claimed in claim 29,
wherein the snap-on element is spherical and includes a connecting element,
wherein the snap-on element and the connecting element are formed in one piece, and
wherein the connecting element is connected to the first part.

31. The behind-the-ear hearing device as claimed in claim 30,
wherein the first part is the receiver, and
wherein the snap-on element, the connecting element and the receiver housing are made of metal and the connecting element is welded to a housing of the receiver.

32. The behind-the-ear hearing device as claimed in claim 30, wherein the hard layer is a coating of the surface of the opening or a separate part in the opening.

33. The behind-the-ear hearing device as claimed in claim 32, wherein the ear mold is formed from a soft, flexible plastic.

34. The behind-the-ear hearing device as claimed in claim 33, wherein at least part of the opening is spherical.
